(19) United States
(12) Patent Application Publication
(10) Pub. No.: US 2005/0094825 A1
(43) Pub. Date: May 5, 2005

(54) Remotely controlled sound generator

(76) Inventors: Gene A. Loness, Elsberry, MO (US); G. L. Winner, Hudsonville, MI (US); L. Nick Nibert, St. Peters, MO (US); David M. Linhoff, St. Peters, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/697,726

(22) Filed: Oct. 30, 2003

(51) Int. Cl. H04B 3/00; H04R 27/00

(52) U.S. Cl. 381/82; 381/77

(57) ABSTRACT

A remotely operated sound generator of the present invention includes a remote control unit and a base unit. The remote control unit comprises a transmitter, a sound selector, and means for activating the sound generator. The base unit comprises a sound memory for storing a plurality of sounds, a speaker, and a receiver. In general operation, a desired sound is selected on the control unit and the control unit is activated. When activated, the control unit will transmit a signal indicative of the selected sound. This signal will be received by the base unit. The base unit will process the signal to determine the selected sound, and, upon determining the selected sound, will broadcasting the selected sound through the speaker. The base unit can be switched to a record mode to allow for the recording of new sounds into blank memory locations or to overwrite pre-recorded sounds.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This application relates to sound generators, such as hunting decoys and novelty sound generators, and, in particular, to remotely activated sound generators.

Sound generators in the form of decoys are commonly used by hunters to attract prey. Some decoys, such as floating duck decoys, are silent, and rely on the prey to see the decoy to attract the prey. Other decoys include calls, and rely on sound to attract the prey to the vicinity of the hunter. Decoy calls, however, must be operated by the hunter. Hence, the decoy is in the vicinity of the hunter, and, sometimes the prey will smell the hunter and stay clear of the area in which the hunter is operating the decoy, effectively rendering the decoy useless. Some decoys include a speaker or sound making device, which can be positioned remotely from the hunter. However, such decoys are complex in construction, difficult to use, and limited in their capabilities.

Other types of sound generators are used to, for example, make Halloween sounds to scare people. Other sound generators are used to make sounds as jokes. In order to best scare or make people laugh with such sound generators, it is preferable if the sound generator can be remotely activated.

### BRIEF SUMMARY OF THE INVENTION

In accordance with the invention, generally stated, a remotely operated sound generator of the present invention includes a remote control unit and a base unit. The remote control unit comprises a transmitter, a sound selector, and means for activating the base unit to generate a recorded sound generator. The base unit comprises a sound memory for storing a plurality of sounds, a speaker, and a receiver. In general operation, a desired sound is selected on the remote control unit and the remote control unit is activated. When activated, the remote control unit will transmit a signal indicative of the selected sound. This signal will be received by the base unit. The base unit will process the signal to determine the selected sound, and, upon determining the selected sound, will broadcast the selected sound through the speaker.

The remote control signal includes an identification code which is read by the base unit, so that the base unit will not be activated by another's remote control unit. The sound generator includes means, preferably in the form of DIP switches, in the remote control unit for setting (and altering) the identification code. The base unit includes a learn switch to switch the base unit from a playback mode to a learn mode. When in the learn mode, the base unit will read the new identification code from the remote control unit signal and record the new code.

The sound generator also includes a switch, preferably in the base unit, which can switch the base unit between a playback and a record mode to allow new sounds to be recorded in the base unit's memory. The base unit includes an input, preferably in the form of a phono-jack which enables the base unit to be connected to a microphone or other device (such as a computer, tape player, CD player, etc.) which can play back pre-recorded sounds. In addition, the base unit can include a built-in microphone. The location in the base unit memory into which the new sound is stored, and the association between the memory location and the signal from the remote control unit, is made by pressing a desired one of the buttons on the remote control unit after the base unit has been placed in a record mode and prior to playing of the new sound. The sound is then received through the microphone or the phono-jack input and recorded in memory. The base unit also includes an output jack which will allow the base unit to be connected to, for example, a computer, to store the sounds stored in the base unit's memory on the computer.

### BRIEF DESCRIPTION OF THE SEVERAL VIEWS OF THE DRAWINGS

FIG. 1 is a block diagram of a sound generator of the present invention, including a remote control unit and a base unit;

FIG. 2 is a back plan view of the remote control unit for the sound generator;

FIGS. 3A and 3B is a front plan views of two versions of the remote control unit, showing that the sound generator can be programmed to contain or store different numbers of sounds;

FIG. 4 is perspective view of a base unit for the sound generator;

FIG. 5 is a plan view showing the jacks and switches behind an access panel on the front of the base unit;

FIG. 6 is a back perspective view of the base unit; and

FIG. 7 is a cross-sectional view of the base unit, showing the batteries, speaker, control board, antenna and access panels of the base unit within the housing.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

In a preferred embodiment, the sound generator 10 of the present invention comprises a remote control unit 11 and a base unit 12. The base and remote control units are both intended to be used outdoors. Hence, the units have housings which are preferably water resistant to insulate the components of the sound generator from water damage. Additionally, the units are built to be sufficiently sturdy to withstand being dropped. As will be described below, a plurality of sounds are stored on the base unit 12, and the base unit is activated by the remote control unit 11 to play a selected sound. The remote control unit includes a sound selector 16 so that a user can select one of the sounds stored in the base unit. When activated by the user, the remote control unit will emit a signal indicative of the desired sound. The base unit receives the signal from the remote control unit, and, based upon the signal received, broadcasts the desired sound over a speaker. The base unit can be positioned remotely from the remote control (and hence remotely from the user). For example, the remote control unit may have a range of 150 to 200 feet. Thus, for example, when the sound generator 10 is in the form of a decoy, the hunter will not have to be close to the base unit when the base unit is activated. Hence, the prey will be less likely to detect the hunter.

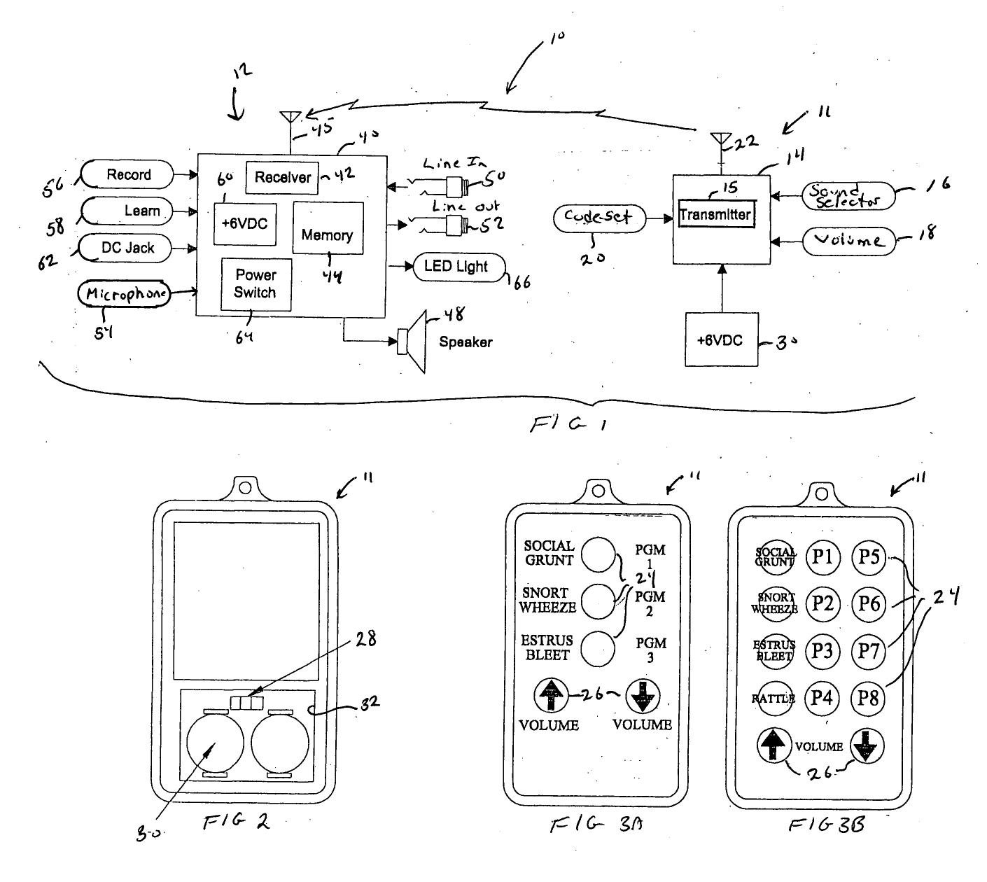

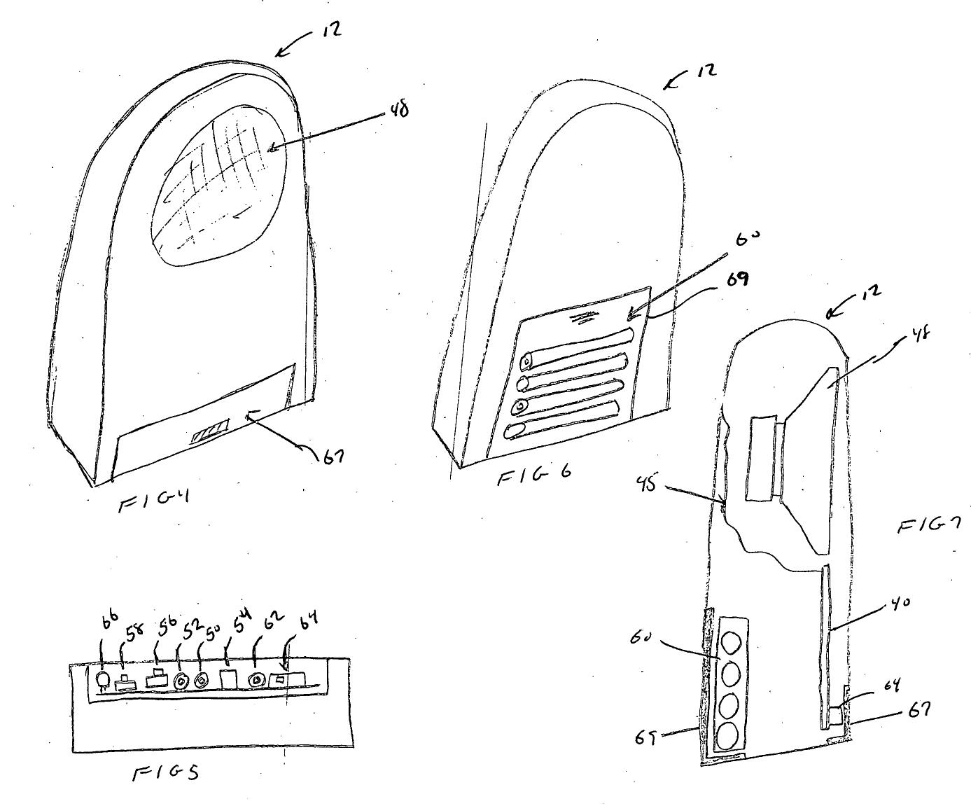

Turning to FIGS. 1-3B, the remote control unit 11 includes a control board 14 having a transmitter 15, a sound selector 16, a volume control 18, a code setter 20, and an antenna 22. As seen in FIGS. 3A and B, the sound selector 16 comprises a plurality of selector buttons 24. The remote control unit of FIG. 3A shows three sound selector buttons, which can be prelabeled for specific sounds, as seen, which have been prerecorded and stored on the base unit. The remote control unit of FIG. 3B includes the prelabeled buttons, but also includes buttons P1-P8 which can be used to record and store additional sounds on the base unit. The volume control 18 also comprises a pair of buttons 26, one of which increases volume and the other of which decreases volume. Although the sound selector 16 and volume control 18 are shown to be buttons, they could also be in the form dials. Additionally, although three sound selector buttons are shown in the remote control unit of FIG. 3A and twelve sound selector buttons 24 are shown in the remote control unit of FIG. 3B, the number of buttons could be altered, as desired. In FIG. 2, it will be seen that the code setter 20 comprises a plurality of DIP switches 28. The remote control unit 11 is powered by batteries 30 which are held in a battery compartment 32 in the back of the housing for the remote control unit. The DIP switches 28 are accessible through the battery compartment, as seen in FIG. 2. The remote control unit is not provided with an power switch. Rather, the unit is normally disconnected from the battery (i.e., the circuit to the battery is normally opened). When a user presses any of the buttons (i.e., a sound selector button or volume control button), the remote control unit 11 will be activated for a period of time sufficient to transmit a signal indicative of which button was pressed. As noted above, the sound generator includes a code which is part of the signal transmitted by the remote control unit.

The base unit 12 includes a control board 40 having a receiver 42, a storage or memory device 44, and an antenna 45. The memory 44 is preferably incorporated into the control board as shown in FIG. 1. The memory 44 can be part of the board's architecture, or can be a memory chip which is added to the board. The memory is preferably of a type, such as an EPROM or EEPROM, which can be rewritten, to enable storage of new and/or additional sounds, as discussed below. Alternatively, the memory can be a removable memory device, such as a flash card. In this case, a port would be provided on the base unit housing to accept the removable memory device. The base unit 12 also includes a speaker 48, an input jack 50, an output jack 52, a built-in microphone 54, a record switch 56, and a code learning switch 58. The base unit is powered by a battery 60, but can be connected to an external power supply by way of a DC power jack 62. A power switch 64 is provided to activate and deactivate the base unit. An LED 66 or other visual indicator is provided on the base unit to give a visual indication of when the base unit is activated. As seen in FIG. 7, the line-in jack 50, line-out jack 52, microphone 54, record button 56, learn button 58, DC jack 62 and light 66 are behind an access panel 67 on the front of the base unit 12. The batteries 60 are stored in a compartment behind a second access panel 69 on the back side of the base unit. As will be described below, the record switch 56 is used to selectively switch the base unit between a playback mode and a record mode to allow for the recording of new sounds. The learn switch 58 is used to selectively switch the base unit between a playback mode and a learning mode to alter the signal code.

The base unit stores a plurality of sounds in the memory 44. Each of the sounds is assigned a different location in the memory 44, and is associated with one of the sound selector buttons 24 on the remote control unit 11. The base unit can be provided with pre-recorded sounds. If desired, these pre-recorded sounds can be permanent, and hence unerasable. Other memory locations can allow for recording of new sounds, and recording of new sounds over existing sounds. Thus, for example, for the recordable memory, sounds for one animal can be recorded onto the base unit, and for the hunting of a different animal, the recordable memory locations can have the new sounds recorded over the old sounds. The sounds can, for example, have a total playing time of 20 seconds. Thus, each recorded sound will play for 20 seconds, regardless of the actual length of the recording. If the recording is, for example, less than 20 seconds, the remaining portion of the play-back will be silent. This playback time can be changed if desired to allow for longer or shorter playback times.

The base unit 12 defaults to a playback mode when initially turned on. In the basic operation of the sound generator, a user will press one of the sound selector buttons 24 on the remote control unit 11. When pressed, the sound selector button 24 will close the circuit of the remote control unit 11, and the remote control unit will be activated to transmit a signal containing the code (which identifies the remote control unit) and information indicative of the sound selector button pressed. The signal is received by the receiver 42 in the base unit 12. The control board 40 (through programming stored on the control board or through circuitry contained on the control board) then analyzes the signal from the receiver 42 first to determine if the code of the signal sent matches the code of the base unit. If the code does not match, then no sound will be played. As will be discussed below, the code can be changed. This will allow several users to use their own sound generators within a short range of each other without activating the sound generator of another user. If the code does match, the signal is analyzed to determine which sound selector button was pressed. For example, each button can be assigned a number (i.e., 1-12), and the signal will contain this number. The control board will, as noted, determine the content of the signal, and play the corresponding sound. For example, if the button is transmits a “1”, the base unit will play the sound in memory location 1 over the speaker 48. Because the sound selection is made at the remote control unit, a user can alternate the sounds broadcast from the base unit without the need to physically contact the base unit. Hence, if the sound generator is a decoy, the user can use a first sound to attract the prey to the vicinity of the user, and, when the prey approaches, the user can play a second sound, without the need to move from his location. If the sound is too loud or too soft, the user can adjust the volume using the volume adjusting buttons 26.

The activation signal can either be an analog or digital signal. If the signal is an analog signal, then the control and base units would be provided with appropriate A/D converters to enable the circuitry to process the signal.

To prevent one user's sound generator from being inadvertently activated by the remote control unit of a different user, the user can change the code in the activation or volume control signals. The user can set the code using the DIP switches 28 on the remote control unit 11. Three DIP switches are shown, hence, the user can set the remote control unit for one of eight different codes. More or fewer DIP switches can be provided. To “teach” the base unit the new code, the user uses the learn switch 58 to switch the base unit from a playback mode to a learn mode. When the base unit is in the learn mode, the user can press any of the buttons on the remote control unit 11. When in the learn mode, the base unit will read the code portion of the signal sent by the remote control unit and store the code in its memory. After the base unit has “learned” or stored the new code, the base unit is switched back to its play back mode. The learn switch 58 can, for example, be a toggle switch, which when pressed once, switches the base unit from its play back mode to its learn mode. Alternatively, the switch 58 can be a spring biased switch which places the base unit in the learn mode only when depressed. When the switch 58 is released, the base unit will automatically return to its playback mode.

In lieu of the learn switch 58, the base unit could be provided with its own set of DIP switches. Then, when the user changes the code using the DIP switches 28 on the remote control unit 11, the user would have to change the DIP switches in the remote unit 12, so that the two sets of DIP switches would be set to the same code value.

Additionally, new sounds can be stored in the memory 44. To record a new sound, the user first switches the base unit from a playback mode to a record mode using the record switch 56. The user then selects which of the buttons on the remote control unit with which the new sound is to be associated and the memory location in which the new sound is to be stored by pressing a desired sound selection button on the remote control unit 11. After the desired button is pressed, the new sound is played to be received by the base unit through the input port 50, or microphone 54. The base unit will then record the new sound in the selected memory location. For example, if after placing the base unit 12 in the record mode, the user presses the button labeled “P8” in FIG. 3B, the new sound, when received, will be stored in the last memory location. If a sound is already stored in, or is otherwise associated with the button “P8”, the new sound will be recorded over the old sound. The new sound can be input from several sources. For example, a microphone can be connected to the jack 50, to allow the user to record desired sounds. Alternately, the new sounds can be transferred from a device (such as a computer, tape player, CD player, etc.) which is capable of playing pre-recorded sounds. To receive a pre-recorded sound the base unit is connected to the device which plays the pre-recorded sound by means of a wire or cable which is plugged at one end into the sound input port 50 of the base unit 12 and is plugged at its opposite end into a sound output port of the device. The device is activated to play the sound, and the sound is transferred to the base unit 12 through the input 50. Alternatively, the sound can be received through the microphone 54. The base unit includes a detector, as is known in the art, to determine if a wire is plugged into the port 50. If a wire were plugged into the port 50, then the base unit will record the new sound received through the input 50. Otherwise, the base unit will record the new sound as received over the microphone 54.

In a further alternative, the remote control unit 11 could be provided with a record button, to remotely switch the base unit 12 between the playback and recording modes. In this instance, the base unit can record a desired sound using the microphone without the need to move from his location. This would allow, for example, for the recording of sounds of animals in the wild.

Also, as noted above, the base unit includes a line out port 52. The line out port allows for the base unit 12 to be connected to a recording device, such as a tape unit or a computer to allow the sounds stored in the memory 44 to be recorded or stored in other media. As described above, in conjunction with the microphone and input jack, the output jack includes a detector which the base unit uses to determine if a connector has been inserted in the line out jack 52. If it is determined that a connector has been inserted in the line out jack, the, when the various sound selector buttons 24 are pressed, the base unit will play the respective sounds through the line out 52 rather than through the speaker. The sound can then be transferred, as noted above, to a tape, computer, or other device capable of recording sounds.

Using the line-in and line-out jacks, a user can transfer one set of sounds from the base unit to a recording media (such as a tape or a computer disk), and load a second set of sounds onto the base unit. By transferring sounds between the base unit and different storage media, a user can acquire a library of sounds, which can then be transferred to and from the base unit as desired by the user, without the need to rerecord the actual sounds.

In view of the above, it will be seen that the sound generator of the present invention is very flexible in its functionality. It allows the user to select from several different sounds which are recorded on the base unit using the remote control unit. Hence, the user can easily choose and play different sounds without having to move from his location. The user can record new sounds on the base unit and transfer sounds from the base unit to a recording device.

As various changes could be made in the above constructions without departing from the scope of the invention, it is intended that all matter contained in the above description or shown in the accompanying drawings shall be interpreted as illustrative and not in a limiting sense. For example, the sound selector buttons 24 could be replaced with a sound selector in a knob format, which is turned to select a desired sound. The remote unit would then include a transmit button (which could be the knob) which, when pressed, causes the remote control unit to transmit a signal indicative of the chosen sound number. This example is merely illustrative.

1. A remotely operated sound generator capable of selectively broadcasting a desired one of a plurality of sounds; said sound generator comprising
a remote control unit comprising a transmitter, a sound selector, and an activator; said remote control unit, when activated, transmitting a signal indicative of a desired one of the plurality of sounds; and
a base unit comprising a sound memory on which a plurality of sounds can be stored, a speaker, and a receiver; said base unit receiving said signal from said remote control unit, and, upon receipt of said signal, broadcasting said one of said selected sounds through said speaker.

2. The remotely operated sound generator of claim 1 wherein said sound selector comprises a plurality of buttons, each button corresponding to a different sound.

3. The remotely operated sound generator of claim 2 wherein said activator comprises said sound selector buttons, whereby a circuit of said remote control unit is normally opened, said circuit being closed when one of said sound selector buttons is pressed to transmit said signal.

4. The remotely operated sound generator of claim 1 wherein said signal includes a code; the sound generator including a switch for altering the signal code.

5. The remotely operated sound generator of claim 4 wherein said switch comprises one or more DIP switches in one or both of said remote control unit and said base unit.

6. The remotely operated sound generator of claim 1 including a record switch to selectively switch said base unit between a play back mode and a record mode and an input for receiving new sounds, whereby, when said base unit is in its recording mode, a sound received through said input is stored at a selected location in said base unit.

7. The remotely operated sound generator of claim 6 wherein said record switch is located on said base unit.

8. The remotely operated sound generator of claim 6 wherein said sound input comprises a microphone.

9. The remotely operated sound generator of claim 8 wherein said input comprises a line in-jack, said line-in jack being adapted to removably connect said base unit to an external microphone or a device capable of playing sounds.

10. The remotely operated sound generator of claim 1 wherein said base unit comprises a line-out jack to removably connect said base unit to a recording device to record the sounds stored in said base unit memory.

11. A remotely operated sound generator capable of selectively broadcasting a desired one of a plurality of sounds; said sound generator comprising:
a base unit comprising a memory for storing a plurality of sounds, a speaker, an activation signal receiver, a switch for selectively switching said base unit between a playback mode and a recording mode; and a sound input.
a remote control unit comprising an activation signal emitter and a sound selector; whereby, when activated, said remote control unit emits a signal indicative of a desired one of the plurality of sounds;
whereby, when said base unit is in its play back mode, said base unit broadcasts a sound chosen with said sound selector upon receiving an activation signal from said remote control unit, and when said base unit is in its record mode, said base unit records a sound received through said sound input in a memory chosen with said remote control unit sound selector.

12. The remotely operated sound generator of claim 11 wherein said sound input comprises a microphone and/or a line-in jack; said line-in jack being adapted to removably connect said sound generator to an external microphone or to a device capable of playing pre-recorded sounds.

13. The remotely operated sound generator of claim 11 including means for associating a sound with a signal from said remote control unit during recording of a new sound.

14. The remotely operated sound generator of claim 13 wherein said sound associating means comprises said sound selector of said remote control unit.

15. The remotely operated sound generator of claim 11 wherein said base unit includes a line-out jack capable of removably receiving a cable to place said base unit in communication with a recording device to record sounds stored in said base unit memory.
